(19) United States
(12) Patent Application Publication
(10) Pub. No.: US 2022/0258519 A1
(43) Pub. Date: Aug. 18, 2022

(54) SECURITY DEVICES AND METHODS OF MANUFACTURE THEREOF

(71) Applicant: DE LA RUE INTERNATIONAL LIMITED, Basingstoke, Hampshire (GB)

(72) Inventor: Brian HOLMES, Fleet (GB)

(73) Assignee: DE LA RUE INTERNATIONAL LIMITED, Basingstoke, Hampshire (GB)

(21) Appl. No.: 17/626,763

(22) PCT Filed: Jul. 10, 2020
(86) PCT No.: PCT/GB2020/051675

§ 371 Date: Jan. 12, 2022

(30) Foreign Application Priority Data
Jul. 12, 2019 (GB) 1910041.1

(51) Int. Cl. B42D 25/324; B42D 25/328; B42D 25/342; B42D 25/373; B42D 25/425

(52) U.S. Cl. CPC B42D 25/324; B42D 25/328; B42D 25/425; B42D 25/373; B42D 25/342

(57) ABSTRACT

device includes an array of reflective sampling elements. A non-dispersive colour-generating relief structure is formed in a surface of the reflective sampling elements. The non-dispersive colour-generating relief structure defines an array of image elements across the array of reflective sampling elements. The array of image elements defined by the non-dispersive colour-generating relief structure and the array of reflective sampling elements cooperate to exhibit an optically variable effect.

### FIELD OF THE INVENTION

The present invention relates to security devices such as those suitable for use in or on security documents such as banknotes, identity documents, passports, certificates and the like, as well as methods for manufacturing such security devices

### DESCRIPTION OF THE RELATED ART

To prevent counterfeiting and enable authenticity to be checked, security documents are typically provided with one or more security elements which are difficult or impossible to replicate accurately with commonly available means, particularly photocopiers, scanners or commercial printers.

Many security devices rely on the interaction between an array of sampling elements, such as an array of microlenses or micromirrors, and an array of image elements, such as a printed array of microimages, to produce an optically variable effect.

One class of such security devices is moiré magnifier devices (examples of which are described in EP 1695121 A, WO 94/27254 A, WO 2011/107782 A and WO 2011/107783 A), which make use of an array of micro-focusing elements (such as lenses or mirrors) and a corresponding array of microimages, wherein the pitches of the micro-focusing elements and the array of microimages and/or their relative locations are mismatched with the array of micro-focusing elements such that a magnified version of the microimages is generated due to the moiré effect. Each microimage is a complete, miniature version of the image which is ultimately observed, and the array of sampling elements acts to select and display a small portion of each underlying microimage, which portions are combined by the human eye such that a whole, magnified image is visualised. This mechanism is sometimes referred to as “synthetic magnification”.

Integral imaging devices are similar to moiré magnifier devices in that an array of microimages is provided with a corresponding array of lenses or micromirrors, each microimage element being a miniature version of the image to be displayed. However, here there is no mismatch between the sampling elements and the microimages. Instead a visual effect is created by arranging for each microimage to be a view of the same object but from a different viewpoint. When the device is tilted, different parts of the images are displayed by the sampling elements such that the impression of a rotation of a three-dimensional image is given.

A problem with these known devices exists in that it is difficult to control the relative positioning of the sampling elements and the microimages. Relatively small changes in relative positioning can have a great impact on the appearance of the final security device. For example, since the position and magnification of the final image will depend on the relative position of each microimage to its corresponding sampling element, positional variation between security devices on the scale of a single sampling element can entirely change the appearance of the final device. This poses a problem for security since different authentic security devices can have significantly different appearances, which affects a viewer's ability to distinguish genuine from counterfeit devices. The problem is further exacerbated when it is desired to use multiple colours in the security device. It is very difficult to achieve register between different colours when using, for example, printing techniques to form the microimages since different colours are typically printed in separate print runs.

Some attempts have been made to solve this problem by using diffractive structures, such as diffraction gratings, to define the image elements. However, diffraction gratings exhibit diffractive dispersion, which means that they diffract white light incident along a single incidence direction into a range of angles in dependence on wavelength. This means that any colour appearance of the diffractive structure will depend on illumination angle and observation angle and can be affected by overlapping diffraction orders. These effects can again contribute to authentic devices appearing different from one another under different illumination and viewing conditions.

It is desirable to provide a security device in which accurate positional control is achievable between sampling elements and coloured image elements and in such a way that a consistent appearance of the security device may be achieved.

### SUMMARY OF THE INVENTION

In accordance with a first aspect of the present invention, there is provided a security device comprising: an array of reflective sampling elements; a non-dispersive colour-generating relief structure formed in a surface of the reflective sampling elements, the non-dispersive colour-generating relief structure defining an array of image elements across the array of reflective sampling elements; wherein, the array of image elements defined by the non-dispersive colour-generating relief structure and the array of reflective sampling elements cooperate to exhibit an optically variable effect.

The present invention uses a non-dispersive colour-generating relief structure to define the array of image elements. Non-dispersive colour-generating relief structures are a class of structure that exhibit colour when illuminated by white light, but do not exhibit diffractive dispersion effects. Specific examples of these structures will be given below, but in essence this means that light is not diffracted by the structure into a cone of angles in dependence on wavelength and, consequently, the structure will not exhibit strong colour variation upon tilting the device or upon changing the illumination angle, as is the case with conventional diffraction gratings.

By forming the non-dispersive colour-generating relief structure directly in an array of reflective sampling elements, it is provided that greatly improved register can be achieved between the array of image elements and the array of reflective sampling elements. For example, it is possible to form the reflective sampling elements and the non-dispersive colour-generating relief structure in a single forming process, e.g. in the same cast-cure step, and so the structures can be integrally registered to one another. This enables the relative positioning to be essentially identical from device to device.

A suitable array of reflective sampling elements would be an array of convex micromirrors. A convex micromirror comprises, essentially, a reflective surface, such as provided by a metal or HRI layer, that is substantially convex along at least one direction (ignoring any surface variation due to the non-dispersive colour-generating relief structure formed therein) to provide a sampling effect. That is, the convex direction of the sampling element may act to ensure that only light from a certain part of the micromirror (and hence from a certain part of the corresponding microimage) is reflected towards a viewer, which part depending on the observation and illumination angle of the diffractive device and thereby providing a variable sampling effect of the corresponding image element.

As indicated above, the array of reflective sampling elements may be a one-dimensional array or preferably may be a two-dimensional array. Preferably, the array of reflective sampling elements comprises an array of substantially semi-cylindrical micromirrors, as an example of a one-dimensional array, or an array of substantially semi-spherical micromirrors, as an example of a two-dimensional array. That is, each micromirror may define a relief having the form of part of a cylinder or part of a sphere. Again, it will be appreciated that this is ignoring any contribution to the shape of the structure from the non-dispersive colour-generating relief structure formed therein. A one-dimensional array will typically exhibit optical variability in only one direction of tilt of the device, e.g. corresponding to the convex direction of the reflective sampling elements, whereas a two-dimensional array will typically exhibit optical variability in two orthogonal directions, preferably in all directions in the plane of the security device.

Other examples of reflective sampling elements include an array of Fresnel micromirrors or an array of diffractive zone plate elements. A Frenesel micromirror Fresnel mirror is essentially an arrangement of facets that substantially replicate the surface of a convex mirror, but eliminate the unnecessary thickness towards the centre of the mirror arrangement by providing each facet at substantially the same height. This structure operates on the same principle as Fresnel lenses, which are well known in the art. These structures have the advantage of reduced thickness compared with the convex structure they emulate. The facets of a so-called diverging Fresnel mirror may be convex to more accurately replicate a convex structure, or may each be substantially planar to approximate respective areas of the replicated convex structure. A diffractive zone plate, on the other hand, uses diffraction to emulate the focussing power of a convex structure. In each case, these structures may be defined by a relief structure and have the non-dispersive colour-generating relief structure defining the image elements superposed thereon.

Typically, the non-dispersive colour-generating relief structure will be modulated across the array of image elements such that the exhibited colour varies across the array of image elements. For example, the colour may vary gradually across the array of image elements. In some embodiments, the non-dispersive colour-generating relief structure is modulated across at least one image element, preferably across each image element, such that the or each corresponding image element is a multi-coloured image element. As noted above, an advantage of generating colour with a non-dispersive colour-generating relief structure is that the whole relief structure can be formed in a single step. It is therefore possible to achieve precise register between different colours, even within the same image element. Therefore, whereas conventional print devices struggle to incorporate multiple colours, the present invention can provide perfectly registered multi-coloured image elements.

According to a particularly preferred example, the non-dispersive colour-generating relief structure comprises an array of plasmonic nanostructures. Plasmonic nanostructures are structures that generate colour from the resonant interactions between light and metallic nanostructures where collective free-electron oscillations within the metallic nanostructure couple to electromagnetic fields in a neighbouring dielectric material. These structures are described in detail in: “Plasmonic Color Palettes for Photorealistic Printing with Aluminum Nanostructures”, Shawn J. Tan et al., Nano Letters, 2014, 14 (7), pp 4023-4029, DOI: 10.1021/n1501460 x; “Color generation via subwavelenght plasmonic nanostructures”, Yinghong Gu et al., Nanoscale, 2015, 7, pp 6409-6419, DOI: 10.1039/C5NR00578G; and “Plasmonic colour generation”, Anders Kristensen et al., Nat. Rev. Mater. 2, 16088, (2016), pp 1-14, DOI: 10.1038/natrevmats.2016.88.

Plasmonic nanostructures are an example of a structure that is capable of generating colour that does not exhibit angular dispersion, as is the case with conventional diffraction gratings, where light rays corresponding to the first order diffractive orders redirected or diffracted by angles (beta) relative to the substrate normal according to the diffraction equation:

$$\frac{λ}{d} = sin α \pm sin β$$

where λ is wavelength of incident light, d is the width of a slit, α is the angle of incidence and β is the angle of first order diffraction. Rather, the surface plasmon polariton resonance effects act to subtract certain parts of the incident light spectrum from the specular reflected light such that a net colour is imparted. For example if the plasmonic resonances act to suppress the reflection of light in the green part of the spectrum (circa 520-550 nm) then the net reflected light will have a magenta hue or colour. Whereas if the blue part of the incident spectrum is suppressed by plasmon coupling in reflection then the net reflected light will have a yellow hue. Note this subtractive colour effect will not be substantially modified by the angle of incidence and reflection and therefore plasmonic nanostructures can be substantially optically invariable, meaning that white light at substantially any angle of incidence will generate substantially the same colour for a particular viewing angle. This intrinsic optical invariability is coupled with the optical variability providable by an array of reflective sampling elements to achieve an optically variable device whose variable appearance is controlled by the sampling effect of the sampling array and not by colour variation owing to diffractive dispersion.

Plasmonic nanostructures are typically sub-wavelength, by which it is meant that they have dimensions less than the wavelength of visible light, e.g. 500 nm or less.

Preferably, the plasmonic nanostructures vary in at least one of their shape, size and spacing across the array of plasmonic nanostructures such that the exhibited colour varies across the array of image elements. Here “shape” refers to the outline of the nanostructure, i.e. the metal cover and/or the dielectric material, “size” refers to the dimensions of the nanostructure and “spacing” refers to the lateral distance between the centres of adjacent nanostructures. Each of these factors affects the colour generated by a region of the plasmonic nanostructure. This phenomenon is described in “Plasmonic Color Palettes for Photorealistic Printing with Aluminum Nanostructures”, Shawn J. Tan et al., Nano Letters, 2014, 14 (7), pp 4023-4029, DOI: 10.1021/nl501460 x. In contrast with printing, different sizes, shapes and spacings, and hence different colours, can be provided within the same forming process and thererby be integrally registered to one another. Varying shape, size and/or spacing of the plasmonic nanostructures can be used to provide varying colour across the array of image elements, thereby allowing production of multicolour effects with integral registration between the colours.

While colour variation across the array is preferable, even more preferably the plasmonic nanostructures vary in at least one of their shape, size and spacing across at least one image element, preferably across each image element, such that the or each corresponding image element is a multi-coloured image element. That is, individual microimages or image elements can have multiple colours. This is even more difficult to achieve with conventional means such as printing, as registration would need to be high enough to accurately arrange different colours within the scale of a single image element. Again, these different colours are defined by the form of the non-dispersive colour generating structure and so the different colours can be produced in a single forming step.

In many embodiments, the array of reflective sampling elements comprises a dielectric layer coated with a metal layer and the array of plasmonic nanostructures formed in the surface of the array of reflective sampling elements comprises a two-dimensional array of nanopillars, each nanopillar comprising a dielectric body provided by the dielectric layer and each nanopillar being topped by a continuous metal cover layer provided by the metal layer and typically further having a complementary metallic hole as a back reflector. Such pillars may be circular in horizontal cross-section, or may have other shapes such as square or oval. As has been mentioned, the shape may be configured to affect the colour generated by the array of plasmonic nanostructures. These nanopillars may have a diameter (largest width) in the range 10 to 500 nm.

In alternative embodiments, the array of reflective sampling elements comprises a dielectric layer coated with a metal layer and the array of nanoholes comprises an array of nanoholes through at least the metal layer. Typically the nanohole will extend into the dielectric layer such that the structure may be defined by the form of the dielectric layer. For example, the hole may be formed in a UV curable material as typically used for cast cure replication of surface relief micro-structures. Typical substrate materials include acrylated oligomers such as acrylic esters of polyesters, polyethers, polyurethanes and epoxy resins. Alternatively, the hole may be formed in suitable thermoplastic materials often based on acrylic (PMMA) or urethane chemistries. The nanohole may further comprise a metal layer at the base of the nanohole.

While plasmonic nanostructures are preferable, other types of non-dispersive colour-generating structure may be used. For example, the non-dispersive colour-generating relief structure may comprise a zero order diffractive structure, such as a zero order diffraction grating. Zero order diffractive structures typically exhibit practically no first or higher order diffractive effects and exhibit effects such as colour effects in the specular direction, thereby lending themselves to the present sampling effect of the sampling array. In contrast, conventional dispersive structures will exhibit effects in all orders, including the zero order, but in most cases the effect in the zero order will not be visually striking, e.g. a dulling of reflection.

The present invention applies in particular to zero order diffractive structures that exhibit rotational colour shift. Such zero order diffractive structures are produced by a rectangular relief structure (or binary relief structure) formed in a substantially transparent material, the relief structure being coated on the peaks and troughs (e.g. by a directional deposition technique) with a transparent high refractive index material (i.e. refractive index of 1.5 or more, preferably 2.0 or more), and further overcoated by a transparent material with an index which substantially matches that of the transparent material in which the rectangular relief structure is formed. The relief structure will typically have a pitch of between 100 nm and 500 nm, preferably between 200 nm and 400 nm, and a peak to trough height of between 200 nm and 600 nm, preferably between 300 nm and 500 nm, most preferably approximately 400 nm. The transparent high refractive index material, (such as ZnS) will typically be applied with a thickness of 50 nm to 200 nm, preferably 100 nm to 200 nm, preferably approximately 150 nm. The precise colour exhibited by the zero order diffractive structure will be determined by the grating depth to pitch ratio, the index difference between high and low material and the thickness of the high index lamella. Further details of such zero order diffractive structures may be found in “Optical Document Security”, by Rudolf van Renesse, 3rd Edition, 2004, Chapter X. The rotational colour shift may provide additional optical variability that depends on the azimuthal orientation of the security device, rather than observation and illumination angle.

As indicated above, preferably the array of image elements comprises a first array of microimages. Preferably, the microimages are multi-coloured, i.e. by modulating the non-dispersive colour-generating relief structure across the array of microimages. Microimages have at least one dimension, typically two orthogonal dimensions, on the micron scale. That is, they typically have a width and/or length on the order of 100 μm or less, and more typically their width and/or length is 50 μm or less. As described above, microimages are typically scaled down versions of an image to be displayed by the security device, and may rely on synthetic magnification through the cooperation of an array of microiamges and the sampling elements to exhibit the final image.

Preferably, the first array of microimages and the array of reflective sampling elements differ in pitch and/or orientation such that they cooperate to exhibit a first optically variable effect owing to the moiré effect. For example, each microimage may be a miniaturised version of an image to be displayed, with the synthetic magnification resulting from the moiré effect displaying an enlarged version of the individual microimages. The microimages need not be identical, although in some cases this will be the case. The microimages may vary in colour across the array, as described above, to provide a static colour to the synthetically magnified images. Alternatively, or additionally, the microimages may vary in form across the array, so that an apparent morphing or switching effect is exhibited by the synthetically magnified image as the security device is tilted.

An advantage of the present invention is that the same non-dispersive colour-generating relief structure may also define a second array of microimages, wherein the second array of microimages and the array of reflective sampling elements differ in pitch and/or orientation such that they cooperate to exhibit a second optically variable effect owing to the moiré effect. Again, these second microimages may be identical to one another, or may vary in colour and or form across the array, so as to produce the desired optically variable effect. However, typically, the second array of microimages will differ from the first array of microimages in at least one of their form and colour, preferably colour.

Whereas separate microimage arrays would typically be formed separately in conventional devices, e.g. printed in separate print runs, multiple arrays of microimages with different forms and colours can be defined by the same non-dispersive colour-generating relief structure and so may be formed in a single process, thereby ensuring integral register. Just as noted above that the position and size of a synthetically magnified image will depend on the relative positioning of an image array and its sampling array, the relative positioning of two different synthetically magnified images will depend on the relative positioning of the two different microimage arrays. In conventional devices, this has meant that synthetically magnified images may have different relative positions in different authentic security devices. Since the sampling array and both arrays of microimages may be defined in the same forming step, i.e. forming the array of reflective sampling elements and the non-dispersive colour-generating relief structure, the relative position of the synthetically magnified images may be precisely controlled.

Preferably, the non-dispersive colour-generating relief structure is modulated across the array of image elements such that the first array of microimages and the second array of microimages differ in colour, i.e. from each other. For example, the first array of microimages may be in blue and the second array of microimages may be in red. Alternatively, each of the first and second arrays may exhibit different gradual colour variation across the respective arrays. For example, the first array may vary from red to yellow across the array and the second may vary from blue to purple. These multiple colours can be provided inherently in register with one another and such that each device exhibits the multiple colours in the same way, i.e. all devices appear identical. This is very difficult for counterfeiters to replicate by typical counterfeiting techniques and so greatly increases the security of the device.

While the different microimage arrays could be provided in different regions of the security device, preferably the first array of microimages and second array of microimages at least partially overlap one another such that the first and second optically variable effects at least partially overlap, and wherein the first array of microimages and second array of microimages differ in pitch and/or orientation such that the overlapping first and second optically variable effects differ in their perceived depth, perceived movement direction and/or magnification factor. This may, for example, be used to produce a synthetically magnified image of the symbol “£5”, in which the “£” and the “5” are provided by the separate arrays but are nonetheless in the correct relative position when the device is viewed along the normal to the device. Tilting of the security device may then cause the “£” and the “5” to move differently as a result of their arrays having different pitches and/or orientations.

As mentioned above, a specific type of microimage based security device would be a so-called integral imaging device, and the present invention would be applicable to these devices also. Therefore, each microimage of the first (or second) array of microimages may define a different view of an object, and the first (or second) array of microimages and the array of reflective sampling elements cooperate to exhibit an image of the object that varies in perspective upon rotation of the security device.

As noted above, one advantage of defining microimages using non-dispersive colour generating relief structures is that they may be produced on a scale not practically achievable using techniques such as printing. Therefore, preferably, at least one, preferably each, of the image elements has a width (and preferably a length) of 5 to 50 μm, preferably 10 to 40 μm. It will be appreciated that these smaller microimages would be harder for counterfeiters to convincingly replicate using conventional counterfeiting techniques.

Preferably, the array of reflective sampling elements comprises a two-dimensional array of reflective sampling elements and wherein the array of image elements comprises a two-dimensional array of image elements. Where multiple arrays of, for example, microimages are provided, preferably each will be two-dimensional. While two-dimensional devices are preferable, one-dimensional moiré and integral imaging devices are also possible and would benefit from the present techniques.

Some embodiments further comprise an anti-reflective microstructure formed in a surface of the reflective sampling elements. Common anti-reflective structures include one or two-dimensional moth-eye relief structures. Anti-reflection structures such as these are designed to reduce reflections arising from abrupt changes in the refractive index at the interface of two materials. The moth-eye structure has a repeating period typically in the range 200-400 nm and a height typically in the range 250-350 nm. An array of surface structures that are smaller than the wavelength of light provides an effectively continuous transition of the refractive index rather than an abrupt change, and reflection is minimised. These structures will therefore reduce reflection even when formed in a reflective surface, e.g. even when coated in a metal reflector layer. This was described in “Artificial Media Optical Properties—Subwavelength Scale” published in the Encyclopaedia of Optical Engineering (ISBN 0-8247-4258-3), Sep. 9, 2003, pages 62-71. Hence, these structures can be directly formed into the surface of the array of reflective sampling elements. Preferably, the structures are formed simultaneously with the relief structure defining the reflective sampling elements themselves and the relief structure defining the non-dispersive colour-generating structure, i.e. in the same formable layer. The whole structure may then be metalized to render the non-dispersive colour-generating structure active and reflective, and to render any unstructured portions of the sampling elements reflective. As noted above, the metalized anti-reflection structure will still operate to minimise reflection. The anti-reflection structures may be used to provide black colours to the optically variable effect by defining black portions of the image elements. For example, where the image elements are microimages, such as a coloured number or letter, the anti-reflection structures may define black regions of the microimages, such as a black outline to the coloured number or letter. Alternatively, the anti-reflection structures may be provided everywhere that the non-dispersive colour-generating structure is not, to provide a substantially black background to the optically variable effect.

As has been described above, on advantage of the present invention is that the array of reflective sampling elements and the array of image elements defined by the non-dispersive colour-generating relief structure may be registered to one another, e.g. so as to have the same relative positioning on each security device.

According to a second aspect of the present invention, there is also provided a security document comprising the security device of the first aspect of the invention, wherein the security document is preferably selected from banknotes, passports, cheques, identity cards, certificates of authenticity, fiscal stamps and other document for securing value or personal identity.

Advantageously, a plurality of security documents may be provided, wherein the array of reflective sampling elements and the array of image elements defined by the non-dispersive colour-generating relief structure are registered to one another such that they have substantially the same relative positioning on each of the plurality of security documents. This consistent relative positioning ensures a consistency in appearance of the security documents so that counterfeits can be more easily recognised by a viewer.

According to a third aspect of the present invention there is provided a method of manufacturing a security device comprising: forming an array of reflective sampling elements; forming a non-dispersive colour-generating relief structure in a surface of the reflective sampling elements, the non-dispersive colour-generating relief structure defining an array of image elements across the array of reflective sampling elements; such that the array of image elements defined by the non-dispersive colour-generating relief structure and the array of reflective sampling elements cooperate to exhibit an optically variable effect.

This corresponds to a method of manufacturing the security device according to the first aspect of the invention. It will be appreciated that the method may be adapted to provide any of the preferable features described above and to manufacture one or more security documents according to the second aspect of the invention.

Preferably, the array of reflective sampling elements comprises a formable layer, and the method comprises forming the formable layer in a single step so as to define the structure of the array of reflective sampling elements and the structure of the non-dispersive colour-generating relief structure. Forming both the sampling elements and the non-dispersive colour-generating relief structure in the same forming step ensures very high register is achieved between the structures and hence a very high register is achieved between the image elements and the sampling effect of the sampling array.

The formable layer may comprise a curable material and the step of forming the formable layer may then be performed using a cast-cure process. This is a particularly preferable way of forming the reflective sampling elements and the non-dispersive colour-generating relief structure. For example, the casting mould may comprise a relief structure that simultaneously defines the reflective sampling elements, such as an array of convex micromirrors, with the non-dispersive colour-generating relief structure shaped into the convex surface of the micromirrors. While preferable, other techniques, such as embossing, may also be used.

Depending on the type of non-dispersive colour-generating relief structure, a different reflective coating may then be applied to complete the reflective sampling elements and the non-dispersive colour-generating relief structure. For example, where the non-dispersive colour-generating relief structure comprises an array of plasmonic nanostructures, the method may further comprise coating the formable layer with a metal layer, such as aluminium. This aluminium layer may enhance the reflectivity of the sampling elements and complete the functional array of plasmonic nanostructures. Alternatively, the non-dispersive colour-generating relief structure may comprise a zero order diffractive structure, in which case the method may further comprise coating the formable layer with a transparent high refractive index layer, which thereby enhances the reflectivity of the formable layer, while ensuring the functioning of the zero order diffractive structure.

### BRIEF DESCRIPTION OF THE INVENTION

The present invention will now be described by reference to the following drawings, of which:

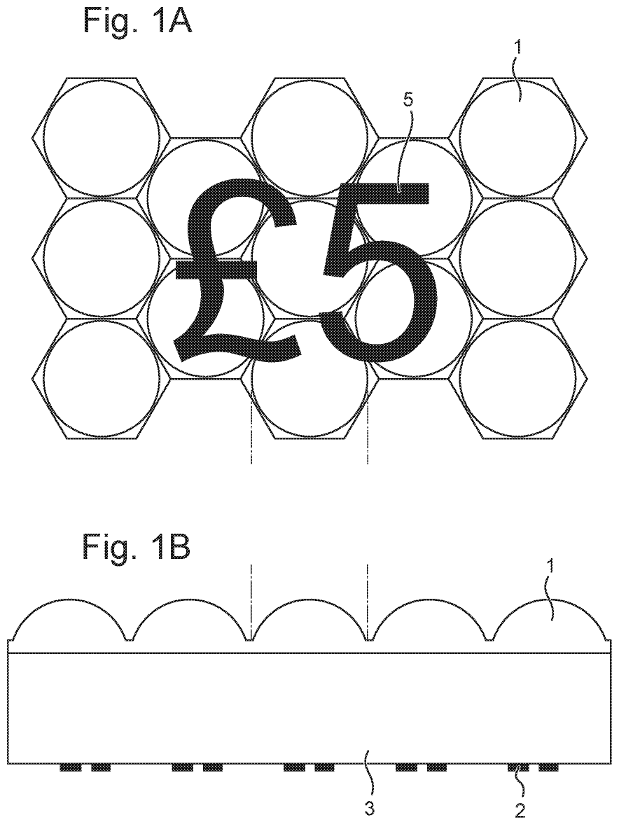

FIGS. 1A and 1B show a known security device in schematic plan view and cross-section view respectively;

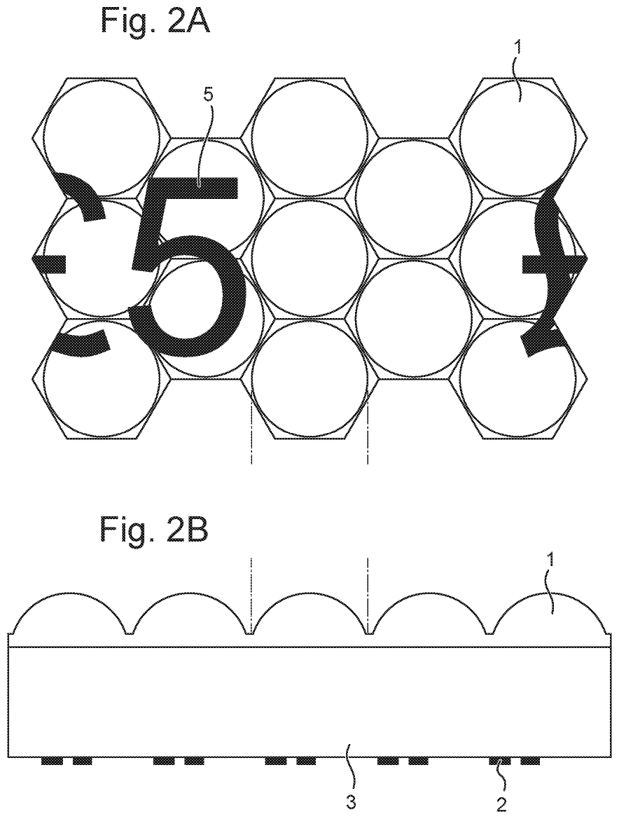

FIGS. 2A and 2B show another known security device in schematic plan view and cross-section view respectively;

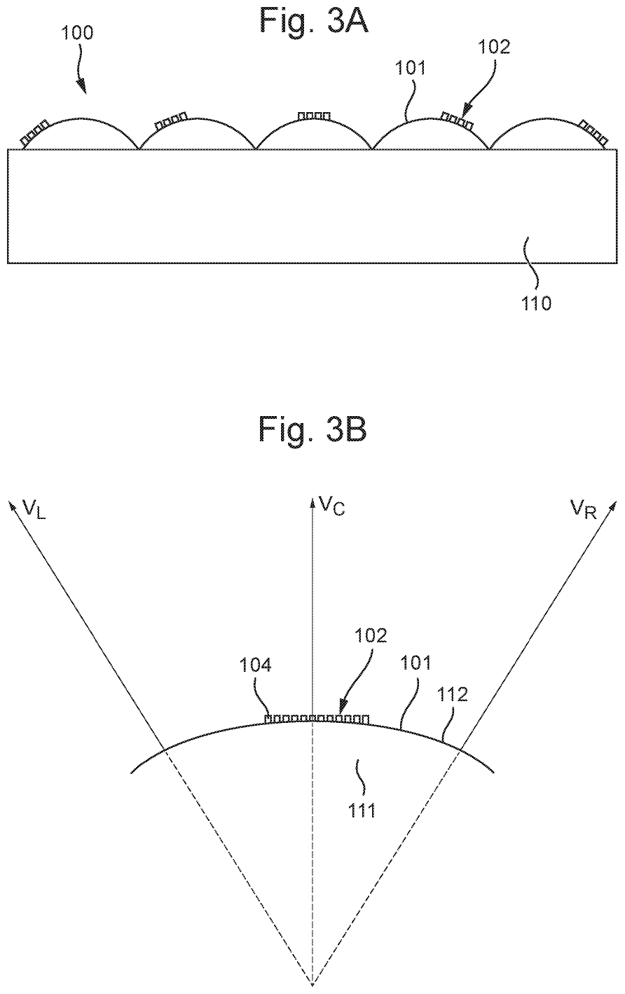

FIG. 3A shows, schematically, a cross-section through a security device according to a first embodiment and FIG. 3B shows, schematically, an enlarged cross-section through one sampling element of the security device;

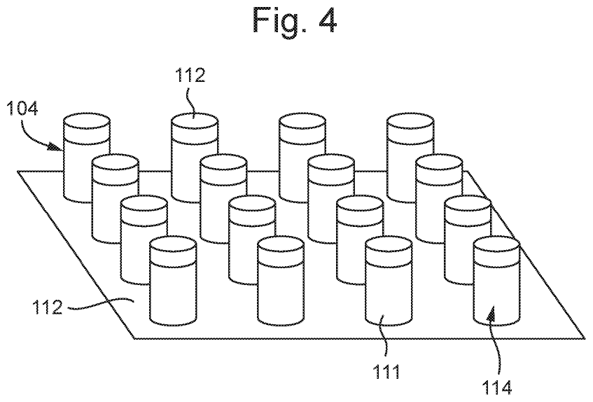

FIG. 4 shows, schematically, a perspective view of a non-dispersive colour-generating relief structure suitable for use in the present embodiments;

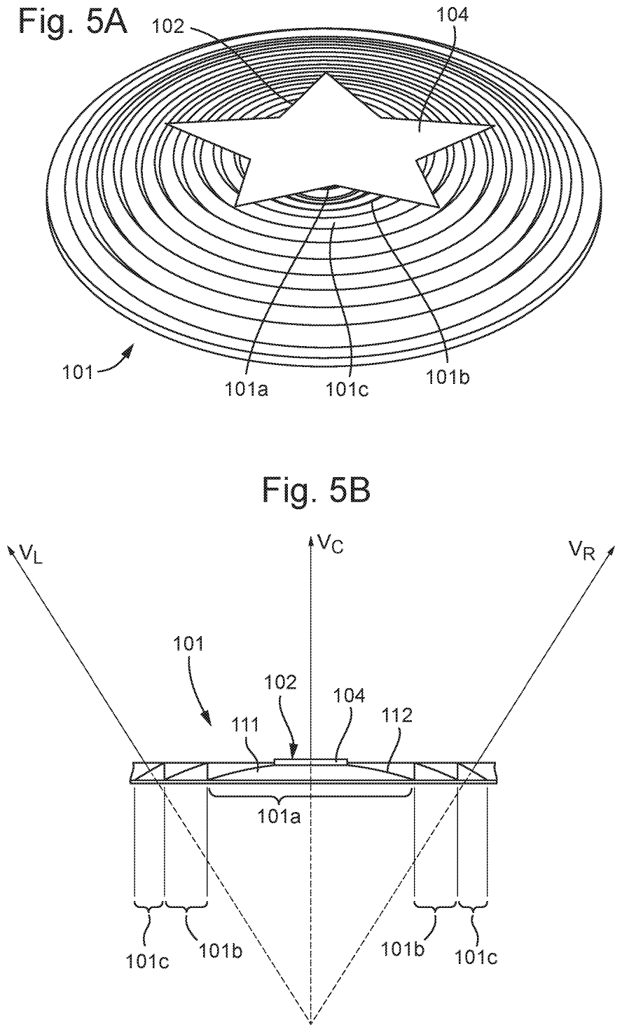

FIGS. 5A and 5B show, schematically, a different type of sampling element, suitable for use in present embodiments in perspective and partial cross-section respectively;

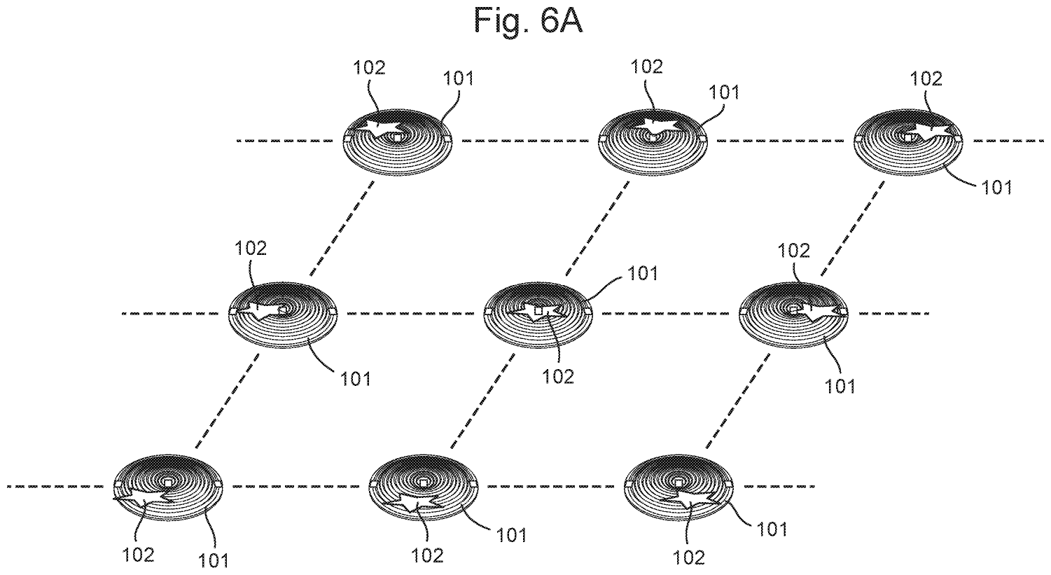

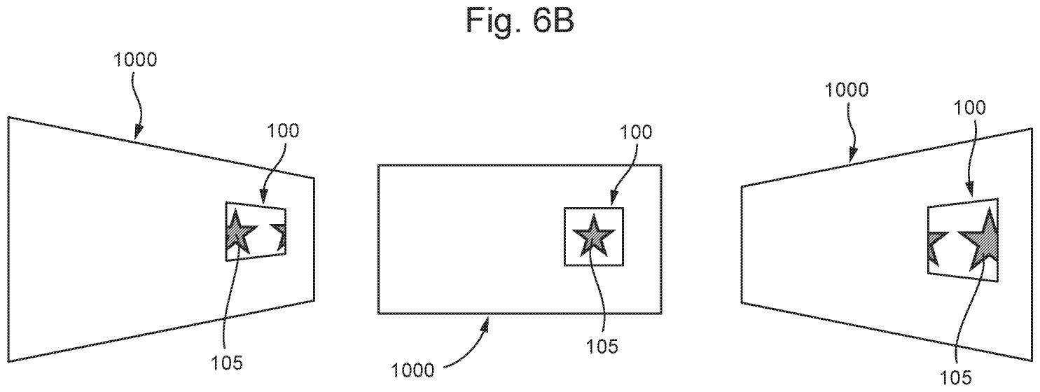

FIGS. 6A and 6B show, schematically, the arrangement of a sampling element array and image element array and the interaction of the two arrays according to a second embodiment respectively;

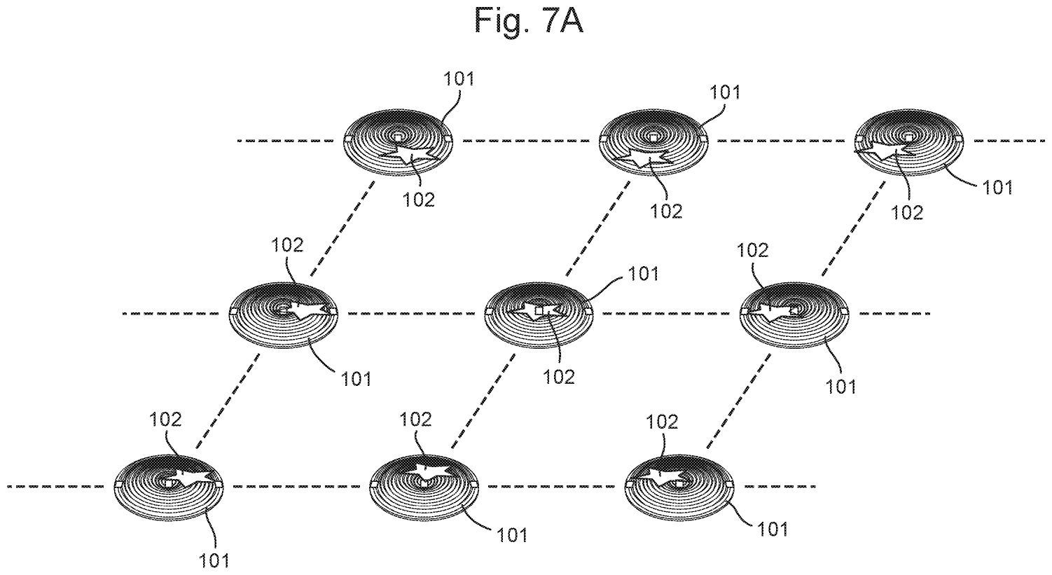

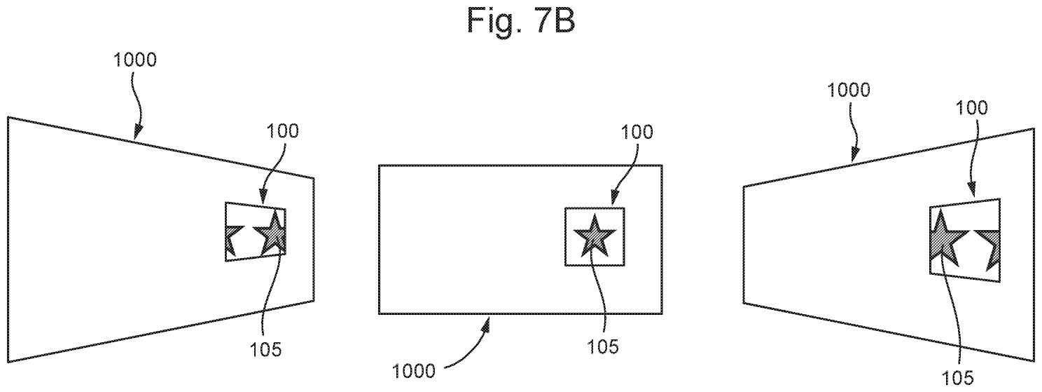

FIGS. 7A and 7B show, schematically, the arrangement of a sampling element array and image element array and the interaction of the two arrays according to a third embodiment respectively;

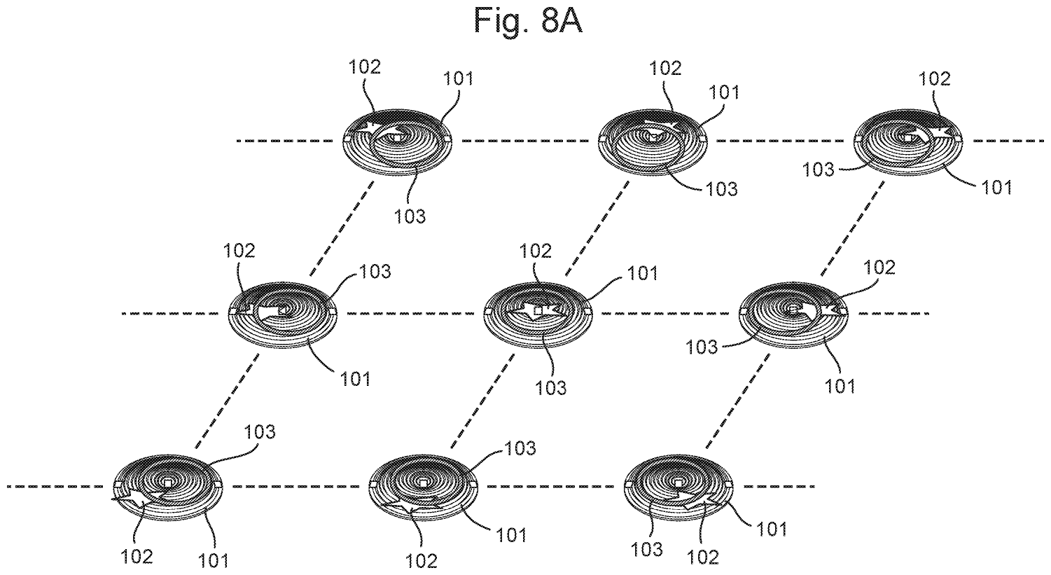

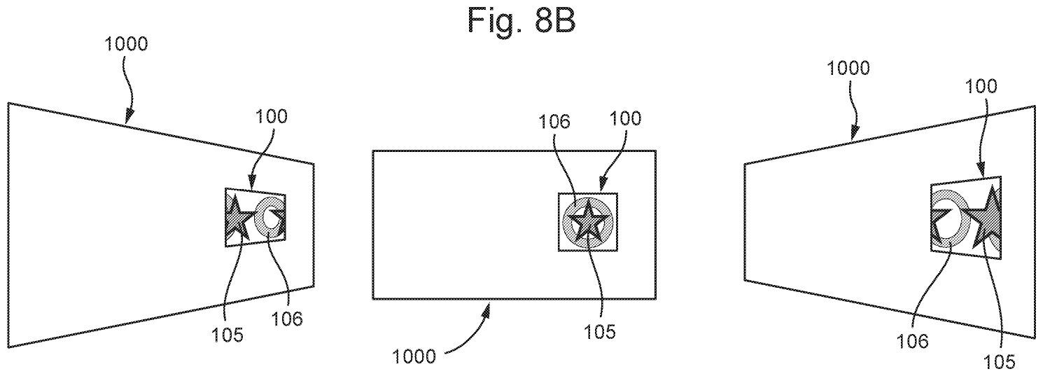

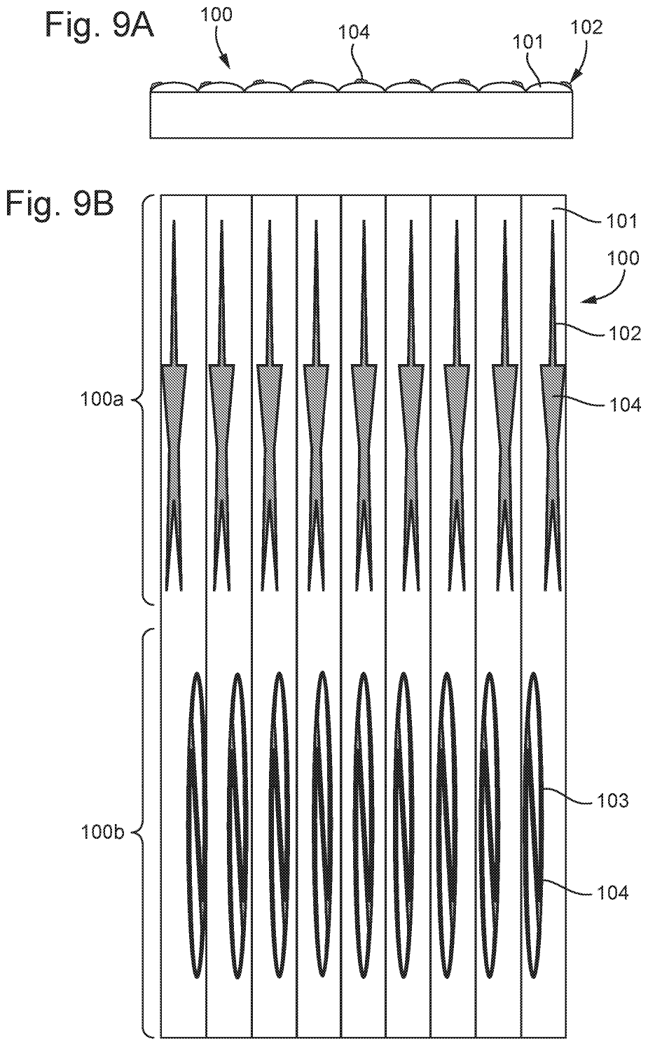

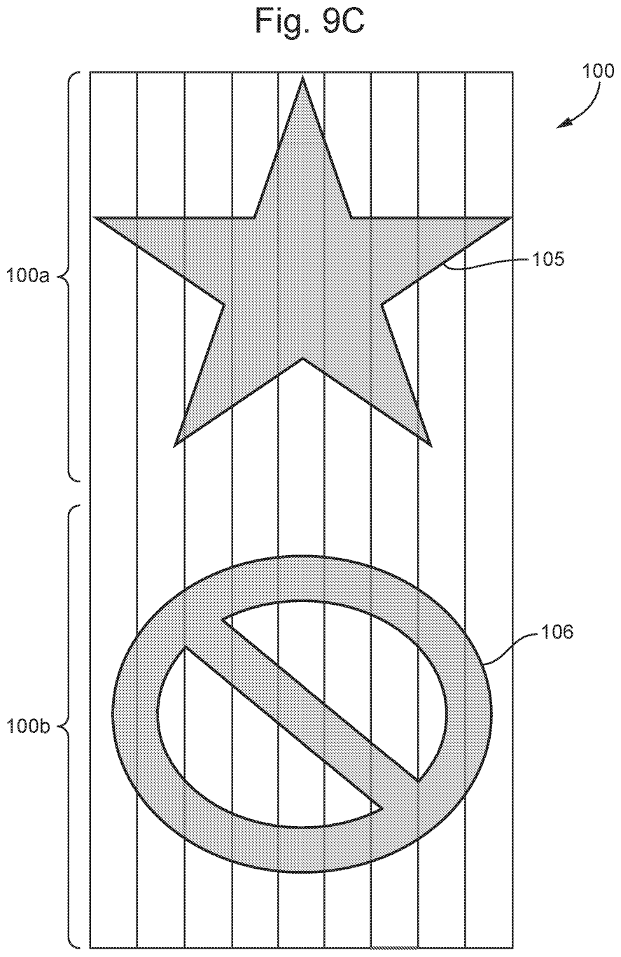

FIGS. 8A and 8B show, schematically, the arrangement of a sampling element array and two image element arrays and the interaction of the three arrays according to a fourth embodiment respectively FIGS. 9A to 9C show, schematically, a cross section through a security device according to a fifth embodiment, and first and second plan views showing the image element array and the resulting image respectively;

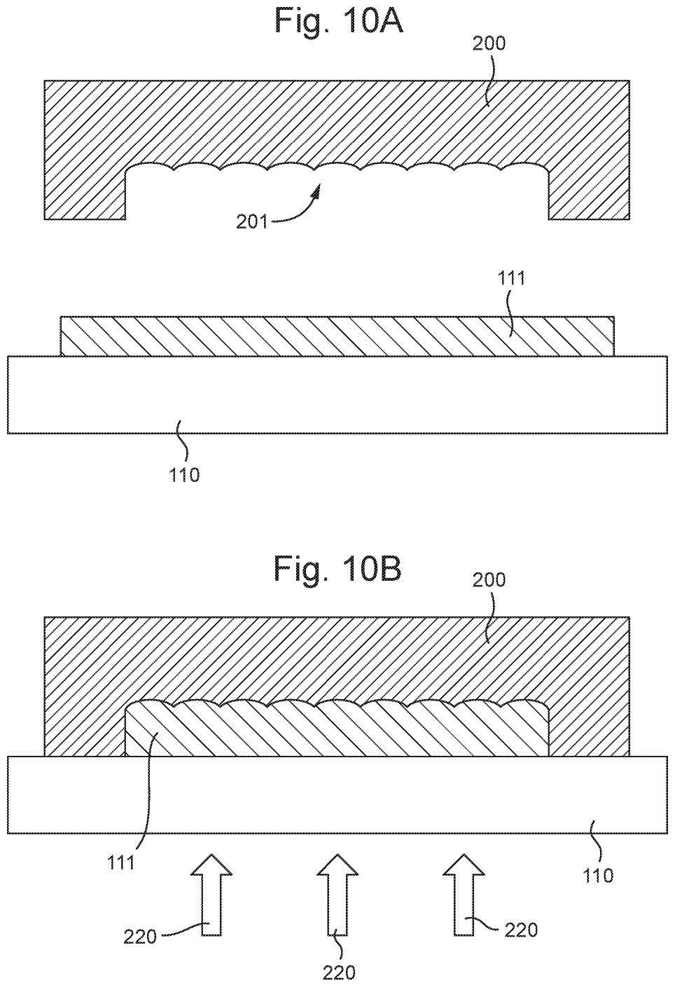

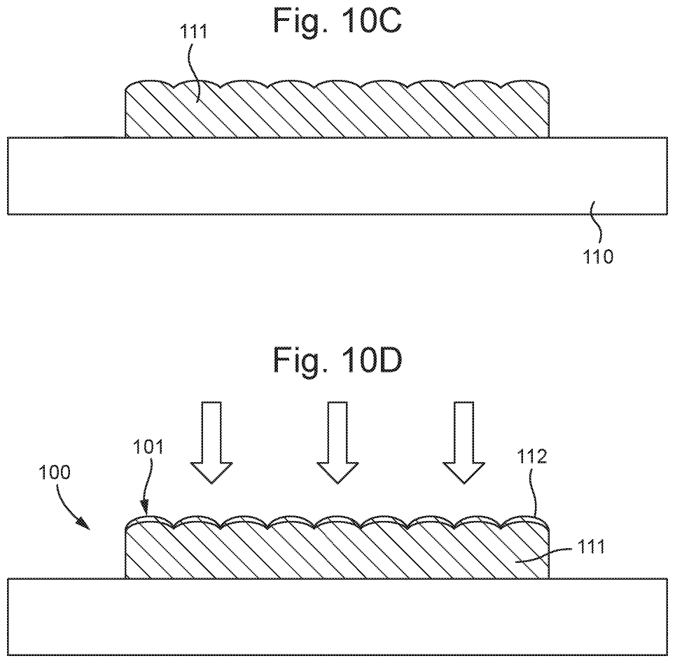

FIGS. 10A to 10D show, schematically, cross-sectional views through a security device according to a fifth embodiment at four different stages during manufacture;

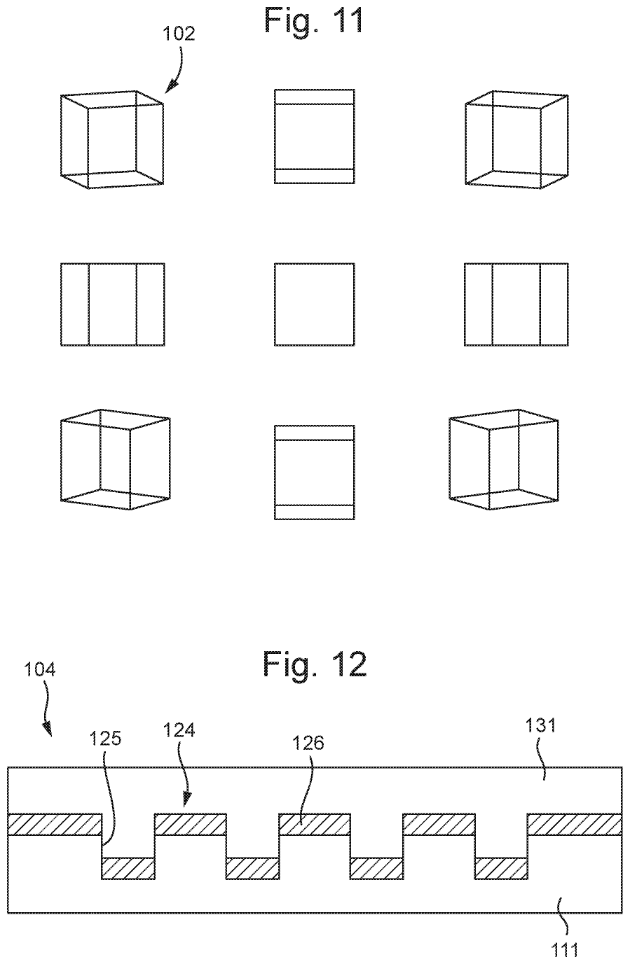

FIG. 11 show nine different image elements from another image element array suitable for use in the present embodiments;

FIG. 12 shows, schematically, a cross-section through a non-dispersive colour-generating relief structure suitable for use in the present embodiments;

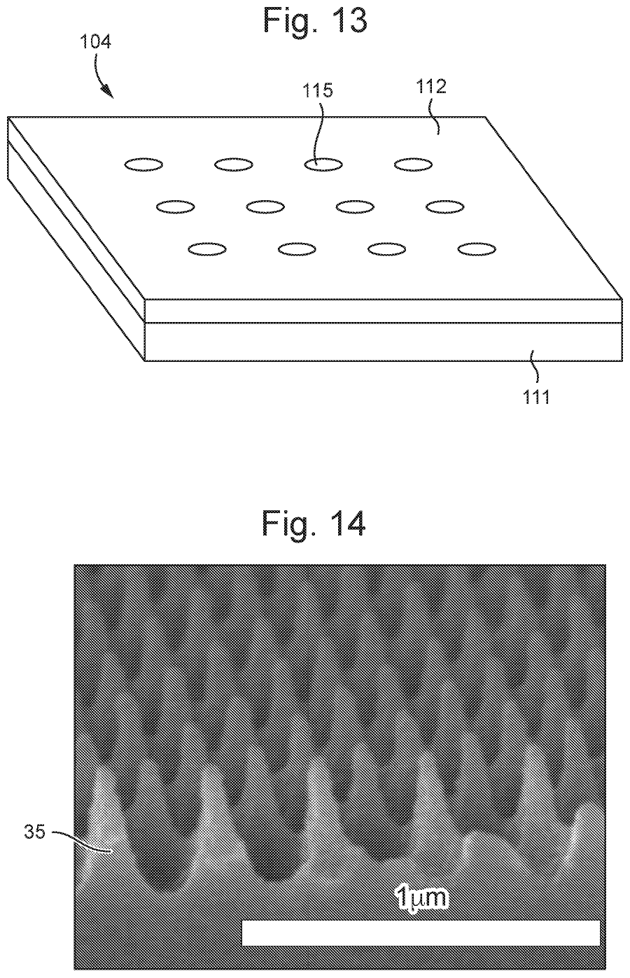

FIG. 13 shows, schematically, a perspective view of another non-dispersive colour-generating relief structure suitable for use in the present embodiments;

and FIG. 14 shows an image of an anti-reflective relief structure suitable for use in present embodiments.

### DETAILED DESCRIPTION

FIGS. 1A to 2B show known security devices that utilise sampling element arrays and image element arrays. These Figures demonstrate the problem that poor registration can pose.

FIG. 1A shows, in plan view, an array of sampling elements, in this case lenses 1. It will be appreciated that this view is schematic, showing only thirteen lenses, whereas in practice many more lenses would typically be used in a security device. FIG. 1B shows the security device in cross-sectional view and shows that the lenses 1 are spaced from an array of printed image elements 2 by an optical spacer layer 3. This is a conventional moiré magnification device, as described in EP 1695121 A, WO 94/27254 A, WO 2011/107782 A and WO 2011/107783 A, and each image element is a microimage, being a miniaturised version of the image to be displayed, in this case, the symbol “£5”.

The pitches of the sampling element array 1 and the image element array 2 are different from one another, such that each sampling element samples a different portion of its underlying microimage, thereby presenting a synthetically magnified version of the microimage 5.

FIGS. 1A and 1B show a device with perfect register, i.e. in which the image elements are located exactly where intended by the designer. In this case, the image elements are located such that the central image element is centred under its corresponding sampling element. As a result, when the device is viewed along the normal to the security device, the synthetically magnified image 5 will be centred on this central sampling element. However, as we have described above, obtaining accurate register of printed image elements is very difficult.

FIGS. 2A and 2B show the same security device shown in FIGS. 1A and 1B, but in a case in which a small amount of misregistration has changed the relative position of the sampling elements 1 and the image elements 2 away from that intended by the designer. As demonstrated in these Figures, a small change in relative position, i.e. less than the width of a single sampling element, will have a large effect on the position of the synthetically magnified image 5. As a result, it is practically impossible to provide security devices exhibiting these types of optical effect in which the appearance is consistent from device to device or in which a preferred position of the magnified image is obtained at a particular viewing angle.

FIG. 3A shows a cross-sectional view through a security device 100 according to an embodiment. The security device comprises a two-dimensional array of sampling elements in the form of convex micromirror elements 101. In this embodiment, each convex micromirror element 101 has the form of a semi-spherical micromirror, being defined by part of the surface of a sphere. Formed in the surface of the micromirror elements is an array of microimages 102 provided by a non-dispersive colour-generating relief structure 104, examples of which will be given below. The convex micromirror elements 101 are supported by support layer 110, which may be a layer of biaxially oriented polypropylene (BOPP), for example.

As can be seen more clearly in FIG. 3B, each sampling element is formed by a layer of cured curable material 111 coated in a reflective layer 112. The formable layer 111 is shaped so as to define the generally convex surface of the convex micromirror elements 101. The metal coating provided over this convex surface enhances reflectivity and ensures the surface acts as a convex micromirror. Additionally, the formable layer has a relatively fine relief structure formed in the generally convex surface that defines a non-dispersive colour-generating relief structure 104. This non-dispersive colour-generating relief structure also receives the metal layer 112, as will be described in more detail below, so that, in this case, it forms a functioning array of plasmonic nanostructures.

FIG. 3B shows a single sampling element and shows the non-dispersive colour-generating relief structure 104 in the form of a microimage centred on the sampling element. As will be appreciated, for a moiré magnification device, the non-dispersive colour-generating relief structure 104 will define microimages with different relative positions on different sampling elements such that there is an pitch and/or orientation mismatch between the array of sampling elements and the array of microimages in order to generate synthetically magnified images due to the moiré effect. However, since the sampling elements 101 and the non-dispersive colour-generating relief structure 104 are both produced by the shape of a single layer, i.e. the formable layer 111, the relative position of the microimages and the sampling elements can be made consistent between devices.

FIG. 3B also demonstrates how the sampling element acts to exhibit only a specific part of the microimage, depending on the viewing conditions. The Figure shows three viewing angles, V_{L}, V_{C}, V_{R} corresponding to a different local surface normal at three different positions across the sampling element. In particular, these exemplary viewing angles correspond to a left side view, a centre view and a right side view. The varying local surface normal provides that light incident along one incoming direction will be reflected in different directions by different areas of the sampling element. Hence, different parts of the microimage 102 will be exhibited by the sampling element at different viewing angles, giving rise to the optically variable effect. Since there exists a pitch or orientation mismatch between the sampling elements 101 and the image elements 102, different sampling elements will exhibit different parts of their corresponding microimage at the same viewing angle, giving rise to the synthetic magnification effect. While only three viewing angles are shown in the Figure, it will be appreciated that the local surface normal varies continuously across the sampling element such that the exhibited part of the microimage varies gradually, for example, as the device is tilted.

FIG. 4 shows one particular non-dispersive colour-generating relief structure 104 in more detail. As mentioned above, this relief structure is formed into the formable layer 111 that defines the convex micromirror elements 101, and thereby defines each microimage 102 for the corresponding micromirror elements 101. In this embodiment the non-dispersive colour-generating relief structure 104 comprises an array of plasmonic nanostructures in the form of nanopillars. The shaft 114 of each nanopillar is formed out of the formable layer 111, which in this embodiment will be a dielectric layer, and preferably a curable dielectric layer. A UV curable material typically used for cast cure replication of surface relief micro-structures may be used, such as acrylated oligomers, such as acrylic esters of polyesters, polyethers, polyurethanes and epoxy resins. The array of nanopillar shafts 114, will typically be cast into the formable layer 111 simultaneously with the relief structure defining the convex surface of the micromirrors, as will be described in more detail below. The surface of the formable layer 111 is additionally coated with a metal layer 112, e.g. by a directional deposition technique. A metal suitable for forming a functioning array of plasmonic nanostructures should be used, such as aluminium. The metal layer is thereby received on the tops of the nanopillar shafts 114 and on the surface between the nanopillars. It will be noted that, since the local surface normal varies across the security device owing to the typically concave or convex nature of the reflective sampling elements, many of the nanopillars will not extend perpendicular to the plane of the security device. However, a directional deposition technique will still form a functioning array of plasmonic nanopillars. This is because, where nanopillars have slight incline, their sides will be very steep, rather than vertical, and a directional deposition will therefore only thinly coat these steep sides of the nanopillars. Suitably thin coatings will form a negligible metal layer which will not impede the plasmonic effect of the final nanopillar array. This same effect will apply equally to other non-dispersive colour-generating structures that are usually formed with a directionally deposited metal or high refractive index layer, e.g. plasmonic nanohole arrays and zero order grating structures. Typical dimensions of nanopillar include diameters between 10 and 500 nm and spacings of 50 to 500 nm. While the nanopillars shown in this Figure are all the same shape and size and equally spaced, it will be appreciated that the desired colour to be generated can be tuned by mixing different sizes and shapes of nanopillar and varying the spacing. Only sixteen nanopillars are shown in FIG. 4, but it will be appreciated that many more are typically used across each sampling element to define each microimage 102.

While the above-described reflective sampling elements have been provided by continuously convex micromirrors, this is not essential, and another type of reflective sampling element will now be described with reference to FIGS. 5A and 5B.

FIG. 5A shows, in perspective view, a single Fresnel micromirror 101 carrying a non-dispersive colour-generating relief structure 104 in its surface defining a microimage 102, in this case a star. FIG. 5B shows a cross section through a central part of the micromirror 101. As with the micromirror shown in FIG. 3B, this Fresnel micromirror 101 comprises a layer of formable material 111, such as a curable material. The formable material 111 is shaped so as to define the profile of the micromirror 101 and the non-dispersive colour-generating relief structure 104 in its surface. In particular, the micromirror 101 comprises a circular central region 101a and a series of annular regions surrounding the central region, only two of which 101b, 101c are shown in the cross-section of FIG. 5B. Each region comprises a facet that defines a convex surface element having the same shape and inclination as a corresponding portion of a (semi)spherical micromirror. However, since each facet is at substantially the same height and has substantially the same thickness, the full range of varying local surface normal is provided without the relatively large thickness of a spherical micromirror. A Fresnel mirror may equally be provided that approximates a semi-cylindrical micromirror by having annular regions with facets defining convex surface elements. As schematically shown in FIG. 5B, the non non-dispersive colour-generating relief structure 104 may be provided across the Fresnel micromirror 101 to define corresponding microimages and may extend across one or more of the regions defined by each facet. Finally, the micromirror includes a reflective coating 112, such as a metal layer, to provide reflectivity and, in the case of plasmonic nanostructures, form a functioning array of plasmonic nanostructures.

FIGS. 6A and 6B show an arrangement of sampling elements and image elements, again microimages in the form of stars, and their cooperation in a final security document. As can be seen in FIG. 6A, the sampling elements, which in this case are Fresnel micromirrors as described above with reference to FIGS. 5A and 5b, are arranged in a two-dimensional array. FIG. 6A only shows only select sampling elements from across the array to illustrate how the relative position of the sampling element and the microimage varies across the array. The Figure omits large areas from the sampling array for clarity; however, it will be appreciated that in practice a large continuous array of sampling elements will be used for a full security device, with the relative positioning of the sampling element and microimages changing gradually across the device.

As described above, each microimage will be defined by the non-dispersive colour-generating relief structure 104, such as the plasmonic nanostructure array described above. Each microimage may be defined, for example, by regions having the plasmonic nanostructure array and regions not having the nanostructure array, and/or the plasmonic nanostructure elements of the plasmonic nanostructure array may vary in one or more of their shape, size and spacing across the array to introduce colour variation, which may contribute to the definition of the microimages (e.g. by defining a blue outline to a red star).

As can be seen in FIG. 6A, the pitch of the array of microimages 102 is larger than the pitch of the array of sampling elements 101 such that their relative positions change across the array. In FIG. 6A, this is depicted by the central sampling element having the microimage centred on it, with the microimage on the left side of the array being towards the left of their sampling elements and those on the right side of the array being towards the right of their sampling elements.

FIG. 6B depicts the interaction of the array of sampling elements 101 and the array of microimages 102, showing a security document 1000 carrying a security device made up of the sampling element and microimage arrays at three different viewing angles. In particular, FIG. 6B shows a banknote carrying the security device, with the central view showing a view of the banknote along a normal viewing direction, the left view showing the banknote rotated about a vertical axis so that the left side of the banknote is closer to the viewer and the right view showing the banknote rotated about a vertical axis so that the right side of the banknote is closer to the viewer.

FIG. 6B shows that the security device exhibits a synthetically magnified image 105, in this case, a single synthetically magnified version of the star depicted in the microimages 102. FIG. 6B illustrates that, because the microimages 102 are formed by a non-dispersive colour-generating relief structure 104 directly in the surface of the sampling elements 101, the sampling elements and the microimages may be formed in a single step. Therefore, their relative position can be controlled such that the security device has a desired appearance at a particular viewing angle. In this case, the device is configured such that, when viewed along a normal viewing direction, i.e. perpendicular to the plane of the security device, and illuminated from above (i.e. typical viewing conditions), the synthetically magnified version of the star appears substantially in the centre of the security device. This is shown in the centre view in FIG. 6B. As the security device is tilted towards the left view shown in FIG. 6B, the synthetically magnified version of the star 105 appears to move left across the device, and as the security device is tilted towards the right view, the star appears to move right across the device, exhibiting the floating effect typical for moiré magnified images. Furthermore, since the relative positioning of the sampling elements 101 and the microimages 102 shown may be consistent between security devices, this makes it possible for different security documents to appear identical and exhibit the same movement effects when viewed in the same viewing arrangement.

While the synthetically magnified image 105 in this embodiment is a single magnified version of the star depicted in each microimage, in other embodiments, the pitches (and/or orientations) of the arrays may be such that the synthetically magnified image depicts multiple versions of the star across the security device.

FIGS. 7A and 7B illustrate another embodiment of a security device.

FIG. 7A again shows an array of sampling elements, as in FIG. 6A, which may again be Fresnel micromirrors 101 as described above with reference to FIGS. 5A and 5B. As can be seen in FIG. 7A, the microimages 102 defined by the non-dispersive colour-generating relief structure 104 are again stars; however, in this embodiment, the pitch of the microimage array is less than that of the array of sampling elements 101. In FIG. 7A, the central sampling element is shown as having the microimage centred on it, while the microimages on the left side of the array are towards the right of their sampling elements and those on the right side of the array are towards the left of their sampling elements.

FIG. 7B shows a banknote carrying the security device at three different viewing positions, with the central view showing a view of the banknote along a normal viewing direction, the left view showing the banknote rotated about a vertical axis so that the left side of the banknote is closer to the viewer and the right view showing the banknote rotated about a vertical axis so that the right side of the banknote is closer to the viewer. Similarly to the embodiment of FIGS. 6A and 6B, the sampling elements and microimages are arranged such that synthetically magnified version of the star appears substantially in the centre of the security device when viewed perpendicularly in typical lighting conditions.

This is shown in the centre view in FIG. 7B. As the security device is tilted towards the left view shown in FIG. 7B, the synthetically magnified version of the star 105 appears to move, this time right across the device. As the security device is tilted towards the right view, the star appears to move left across the device. The security device therefor exhibits an opposite movement effect to that described above with respect to FIGS. 6A and 6B. Again, since the relative positioning of the sampling elements 101 and the microimages 102 shown may be consistent between security devices, it is possible for different security documents to appear identical and exhibit the same movement effects when viewed in the same viewing arrangement.

FIGS. 8A and 8B illustrate another embodiment of a security device. In this case, the security device comprises an array of sampling elements 101 and two different arrays of microimages 102, 103 formed by the non-dispersive colour-generating relief structure. In particular, the device comprises a first array of microimages 102 in the form of stars, with the array having a larger pitch than that of the array of sampling elements 101, and a second array of microimages 103 in the form of rings, with the array having a smaller pitch that that of the array of sampling elements 101. These differing pitches again mean that the array of sampling elements 101 cooperate with the microimages and generate an optically variable effect due to the moiré effect.

The microimages 102 and 103 are formed by the non-dispersive colour-generating relief structure that is provided directly in the surface of the array of sampling elements 101. In this case, the microimages are formed with different colours, e.g. the stars may be blue and the rings red, by varying the parameters of the non-dispersive colour-generating relief structure. As described above, each microimage may alternatively be multi-coloured and/or the colour may vary across the respective arrays by appropriately controlling the parameters of the non-dispersive colour-generating relief structure. The microimages may also be more complex than the rings and stars shown in this embodiment for clarity of the understanding of the invention and may even be, for example, full colour images, e.g. portraits.

FIG. 8B illustrates the cooperation of the sampling elements 101, the first array of microimages 102, and the second array of microimages 103. This Figure again shows a banknote carrying the security device at three different viewing positions, with the central view showing a view of the banknote along a normal viewing direction, the left view showing the banknote rotated about a vertical axis so that the left side of the banknote is closer to the viewer and the right view showing the banknote rotated about a vertical axis so that the right side of the banknote is closer to the viewer.

As with the embodiments of FIGS. 6A to 7B, the sampling element array 101 cooperates with the first microimage array 102 to produce a first synthetically magnified image 105, which again is a magnified version of the star depicted in the microimages 102. Additionally, the sampling element array 101 cooperates with the second microimage array 103 in a similar manner to produce a second synthetically magnified image 106, this time a magnified version of the ring depicted in the microimages 103. Again, because the microimages 102, 103 are formed by the same non-dispersive colour-generating relief structure 104 directly in the surface of the sampling elements 101, the relative position of the sampling elements and microimages can be precisely controlled. In this embodiment, the relative positions are such that that both synthetically magnified images, i.e. of the star and the ring, appear substantially in the centre of the security device when viewed perpendicularly in typical lighting conditions. Hence, the image of the star 105 appears within the image of the ring 106 when the device is viewed perpendicularly.

In this embodiment, because the pitch of the second array of microimage 103 is larger than the pitch of the array of micromirrors 101, while the pitch of the first array of microimages 102 is smaller than the pitch of the array of micromirrors 101, the first and second synthetically magnified images will move in opposite directions upon tilting of the security device. This provides a visually very striking effect. This is demonstrated in FIG. 8B, in which it can be seen in the left and right side views of the security document that the synthetically magnified images 105, 106 appear to have moved away from each other upon rotation of the security device such that they are no longer in alignment. However, because all three arrays are defined by the same surface relief structure it is possible to ensure that the microimages, and hence the synthetically magnified images, have a predetermined relative position in any one viewing configuration, such that each security document exhibits the same relative movement of the synthetically magnified images upon rotation of the security document.

The above described embodiment provides a complex optically variable effect that can nonetheless be easily recognised and authenticated by a viewer. For example, the viewer may check that the synthetically magnified images 105, 106 move into alignment with one another as the viewer rotates the device towards a perpendicular viewing arrangement.

While a ring and a star are used in the above embodiment, other, more easily recognisable image combinations could be used so that a viewer can easily identify correct relative positioning of the arrays. For example, the first array of microimages could define a symbol indicating a currency type, e.g. “£”, while the second array of microimages could define a symbol indicating currency value, e.g. “10”. The security device may then be designed such that the symbols read “£10”, when the security device is, for example, illuminated from overhead and viewed generally along the normal to the security device.

The above embodiments have focused on two-dimensional sampling element arrays and correspondingly two-dimensional microimage arrays. However, other embodiments are possible in which one-dimensional sampling elements and microimages are used. An example of such a security device will now be described with reference to FIGS. 9A to 9C.

FIG. 9A shows a cross-section through a security device 100. The security device comprises an array of semi-cylindrical micromirrors 101, which act as the sampling element array. These Figures show only 9 micromirrors and, similarly, 9 microimages in each microimage array, but it will be appreciated that this is merely schematic and that typically many more micromirrors will make up the security device. As can be seen in FIG. 8B, this security device 100 comprises two distinct regions 100a and 100b adjacent to one another along a first direction of the security device. The semi-cylindrical micromirrors each extend along the first direction in the plane of the security device making up the full length of the security device and extending through both the first and second regions 100a and 100b. The micromirrors repeat along a direction perpendicular to their length, making up the width of the security device, this width being the same for both of the first and second regions 100a, 100b.

The first region 100a comprises a first microimage array 102 formed by the non-dispersive colour-generating relief structure 104. Again, for example, an array of plasmonic nanostructures may be arranged in the surface of the micromirror to define the array of microimages. In this case, each microimage 102 depicts a star. However, since the sampling element array 101 in this embodiment is one dimensional, the synthetic magnification effect will only be present along this one repeat direction of the sampling element array. Accordingly, the microimages 102 are only of reduced size in the direction parallel to the repeat direction of the sampling element array 101. That is, each microimage has a length that is substantially the full length of the first region 100a, while their width is on the micron scale. Further, in order to produce the synthetic magnification effect, the pitch of the microimages 102 along their width direction is slightly greater than the pitch of the sampling element array 101.

Similarly, the second region 100b comprises a second microimage array 103 formed by the non-dispersive colour-generating relief structure 104. In this case, each microimage 102 depicts a stop symbol and again may be defined by an array of plasmonic nanostructures formed in the surface of the micromirrors. Again, since the sampling element array 101 in this embodiment is one dimensional, the synthetic magnification effect will only be present along this one repeat direction of the sampling element array. Accordingly, the microimages 103 are also only of reduced size in the direction parallel to the repeat direction of the sampling element array 101. Whereas the pitch of the first array of microimages 102 was greater than that of the sampling element array, the pitch of this second microimage array 103 is less than that of the sampling element array. This will likewise produce the synthetic magnification effect, but will result in different motion of the corresponding magnified image.

FIG. 9C shows the appearance of the security device. In region 100a, a synthetically magnified first image 105 is visible, which depicts the same star represented in the first array of microimages 102. This first image 105 has the same height as the microimages 102 since there is no synthetic magnification in this direction, but has a width much greater than the size of the microimages. In region 100b, a synthetically magnified second image 106 is visible, which depicts the same stop symbol represented in the second array of microimages 103. Again, this second image 106 has the same height as the microimages 103 since there is no synthetic magnification in this direction, but has a width much greater than the size of the microimages.

As the security device 100 is tilted along the direction parallel to the repeat direction of the sampling element array 101, the synthetically magnified images 105 and 106 will appear to move owing to the moiré effect. However, since the first and second arrays of microimages have different pitches, these images will move in opposite directions, giving the device a visually striking appearance. Furthermore, the relative position of the synthetically magnified images 105 and 106 at any one viewing angle will be the same between security devices and can be precisely controlled by the designer of the security device.

A method of manufacturing a security device will now be described with reference to FIGS. 10A to 10D.

The surface structure, including both the convex micromirror profile and the non-dispersive colour-generating relief structure profile can be provided in a master die, for example by using e-beam lithography. FIG. 10A shows a master die 200 with a negative of the desired surface structure 201. This surface structure in the die defines negatives of the array of micromirrors 101, including, for example, a plasmonic nanostructure array as the non-dispersive colour-generating relief structure 104. FIG. 10A also shows a transparent support layer 110, which may be a layer of the final security device 100. On the surface of the transparent support layer 110 is provided a UV curable material 111. In alternative embodiments, the curable material 111 is directly applied onto the security document and the surface relief subsequently formed in the surface of the curable material while on the security document. This alternative requires no subsequent transferal of the security device onto a security document. In yet further alternatives, the security element may be formed directly into the substrate of the security document by using a formable polymer substrate in place of the UV curable material 111.

FIG. 10B shows the die 200 being brought into contact with the curable material 111 so as to form the curable material into the desired surface shape, i.e. into a series of micromirrors with non-dispersive colour-generating relief structure provided in the surface thereof. FIG. 10B also illustrates that the curable material 111 is exposed to UV radiation 220 through the transparent support layer 110, while in contact with the die 200.

FIG. 100 shows the cured curable material 111 after separation from the die 200. The cured curable material now exhibits an array of convex surface elements with non-dispersive colour-generating relief structure provided in the surface thereof. However, at this stage, the device may not yet be reflective and the non-dispersive colour-generating relief structure may not yet be complete and functional.

FIG. 10D shows a cross section of the final security element 100 after the surface has been coated in a reflection enhancing layer 112, in this case a coating of aluminium. The reflection enhancing layer may be formed on the surface of the security element using a vapour deposition process, for example, a directional deposition technique. As can be seen here, the security device now comprises an array of reflective micromirrors 101, in the surface of which is formed a non-dispersive colour-generating relief structure, such as an array of plasmonic nanostructures.

FIG. 11 shows an alternative arrangement of microimage suitable for use in the above security devices. While the above devices have all used identical microimages, this is not essential. One class of device that uses different microimages is an integral imaging device, as noted above. Here, each sampling element will be provided with a corresponding microimage 102 that is a different perspective view of the same 3D object. Only nine microimages arranged in a three by three grid are shown in FIG. 11 to demonstrate this, but it will be appreciated that typically many more than nine sampling elements will be provided and so more different microimages will correspondingly be required. The nine microimages shown in FIG. 11 merely demonstrate how the microimages will vary across the device.

In particular, the centre microimage shown in FIG. 11 shows a cube as viewed face on. This may be provided as the central microimage of the microimage array, i.e. and be arranged on the central sampling element. While the Figure shows the microimage as a simple black and white outline of a cube, it will be appreciated that more complex image forms will typically be used. For example, different faces of the cube could be provided in different colours, e.g. by varying the characteristics of the non-dispersive colour-generating relief structure across each microimage. Alternatively, entirely different 3D objects could be provided, such as a full-colour profile of a person.

The left and right microimages on the middle row in FIG. 11 depict the same cube shown in the central microimage, but rotated about its vertical axis in opposite directions. Similarly, the top and bottom microimages on the middle column depict the same cube, but rotated instead about their horizontal axis in different directions. Finally, those microimages at the corners of the grid are each a corresponding perspective of the same cube.

As has been described above, an array of microimages such as shown in FIG. 11 may be arranged on a corresponding array of reflective sampling elements so as to exhibit a synthetically magnified version of the cube shown. When the device is tilted, different parts of the images are displayed by the sampling elements such that the impression of a rotation of a three-dimensional image is given.

FIG. 12 shows another type of non-dispersive colour-generating relief structure 104, which may be used in the above described embodiments. Here, the structure is a zero-order diffraction grating 124. This structure comprises a transparent formable layer 111, into which is formed a rectangular grating relief structure 125. The relief structure will typically have a pitch of approximately 300 nm and a depth of approximately 400 nm, although the precise values will depend on the desired colour to be exhibited by the structure. The grating relief 125 is coated, such as by a directional deposition technique, with a transparent high refractive index material 126. This transparent high refractive index material 126 is received on the peaks and the troughs of the rectangular grating relief structure 125 and contributes to the formation of the non-dispersive colour-generating relief structure, while also providing a high reflectivity of the convex surface in which the grating relief structure 125 is formed. The transparent high refractive index material 126, (such as ZnS) will typically be applied with a thickness of approximately 150 nm. Finally, the structure is overcoated with a transparent conformal layer 131 that substantially matches the refractive index of the formable layer 111. The method described with reference to FIGS. 10A to 10D may be adapted to form this type of non-dispersive colour-generating relief structure by providing a final step of overcoating the relief structure with conformal layer 131.

The arrangement shown in FIG. 12, when illuminated with white light, will exhibit a colour without exhibiting diffractive dispersion. The precise colour exhibited by the zero order diffractive structure will be determined by the grating depth to pitch ratio, the index difference between high and low material and the thickness of the high index lamella.

FIG. 13 shows another alternative non-dispersive colour-generating structure 20, which may be used in the above described embodiments. In particular, this Figure shows a different type of plasmonic nanostructure to that described above with reference to FIG. 4, that is, an array of nanoholes. A continuous layer of dielectric material is provided as formable layer 111, which is the layer used to define the array of reflective sampling elements 101. The layer of dielectric material 111 is then coated on its upper surface in a layer of metal 112. The metal layer 112 includes an array of circular holes 115 formed through the metal layer, exposing the dielectric layer. This structure may be formed by providing corresponding holes extending part way into the dielectric material 111 and then directionally coating this relief with a metal layer such that the metal is received in the holes and on the areas surrounding the holes. This structure produces plasmonic colour effects in much the same way described above with respect to nanopillar structures. Again, the shape of the holes, the size of the holes and their spacing can be varied in order to control the colour generated by these plasmonic nanostructures.

FIG. 14 is an image of an array of anti-reflective nanostructures 35. As can be seen in this image, each nanostructure comprises a post that tapers from a relatively wide base to a relatively narrow point. Such a structure may be formed directly in the surface of the formable material 111 that defines the array of reflective sampling elements 101. This structure works by providing an interface between two materials that has an average refractive index that varies gradually along the direction of light propagation. Such gradually varying refractive index minimises reflection of incident light rays. Furthermore, this principle operates even when the structure is coated in a reflective material. Therefore, the anti-reflective nanostructures 35 may be formed simultaneously with the array of reflective sampling elements and the relief defining the non-dispersive colour-generating structure and subsequently coated in the reflection enhancing material 112 needed to render the reflective elements reflective and the non-dispersive colour-generating structure functional. As described above, the anti-reflection structures may be provided within the non-dispersive colour-generating structure to provide black colours to the optically variable effect by defining black portions of the image elements. Alternatively, the anti-reflection structures may be provided as a background to the non-dispersive colour-generating structure, to provide a substantially black background to the optically variable effect. Security devices of the sorts described above are suitable for forming on security articles such as threads, stripes, patches, foils and the like which can then be incorporated into or applied onto security documents such as banknotes. The security devices can also be constructed directly on security documents, such as polymer banknotes.

Security devices of the sorts described above can be incorporated into or applied to any product for which an authenticity check is desirable. In particular, such devices may be applied to or incorporated into documents of value such as banknotes, passports, driving licences, cheques, identification cards etc. The security device can either be formed directly on the security document (e.g. on a polymer substrate forming the basis of the security document) or may be supplied as part of a security article, such as a security thread or patch, which can then be applied to or incorporated into such a document. The security element may be applied to a security document, for example by using a pressure sensitive adhesive.

Such security articles can be arranged either wholly on the surface of the base substrate of the security document, as in the case of a stripe or patch, or can be visible only partly on the surface of the document substrate, e.g. in the form of a windowed security thread. Security threads are now present in many of the world's currencies as well as vouchers, passports, travellers' cheques and other documents. In many cases the thread is provided in a partially embedded or windowed fashion where the thread appears to weave in and out of the paper and is visible in windows in one or both surfaces of the base substrate. One method for producing paper with so-called windowed threads can be found in EP 0059056 A1. EP 0860298 A2 and WO 03095188 A2 describe different approaches for the embedding of wider partially exposed threads into a paper substrate. Wide threads, typically having a width of 2 to 6 mm, are particularly useful as the additional exposed thread surface area allows for better use of optically variable devices, such as that presently disclosed.

Base substrates suitable for making security substrates for security documents may be formed from any conventional materials, including paper and polymer. Techniques are known in the art for forming substantially transparent regions in each of these types of substrate. For example, WO 8300659 A1 describes a polymer banknote formed from a transparent substrate comprising an opacifying coating on both sides of the substrate. The opacifying coating is omitted in localised regions on both sides of the substrate to form a transparent region. In this case the transparent substrate can be an integral part of the security element or a separate security element can be applied to the transparent substrate of the document. WO 0039391 A1 describes a method of making a transparent region in a paper substrate.

The security device may also be applied to one side of a paper substrate, optionally so that portions are located in an aperture formed in the paper substrate. An example of a method of producing such an aperture can be found in WO 03054297 A2. An alternative method of incorporating a security element which is visible in apertures in one side of a paper substrate and wholly exposed on the other side of the paper substrate can be found in WO 2000/39391 A1.

The security device of the current invention can be made machine readable by the introduction of detectable materials into one or more of the layers or by the introduction of separate machine-readable layers. Detectable materials that react to an external stimulus include but are not limited to fluorescent, phosphorescent, infrared absorbing, thermochromic, photochromic, magnetic, electrochromic, conductive and piezochromic materials.

Particularly in embodiments in which the non-dispersive colour-generating relief structures are metallised, e.g. in which plasmonic nanostructures comprising a layer of aluminium are used, the security device can be used to conceal the presence of a machine readable dark magnetic layer, for example, provided beneath the formable layer 111. When a magnetic material is incorporated into the device the magnetic material can be applied in any design but common examples include the use of magnetic tramlines or the use of magnetic blocks to form a coded structure. Suitable magnetic materials include iron oxide pigments (Fe₂O₃ or Fe₃O₄), barium or strontium ferrites, iron, nickel, cobalt and alloys of these. In this context the term “alloy” includes materials such as Nickel:Cobalt, Iron:Aluminium:Nickel:Cobalt and the like. Flake Nickel materials can be used; in addition Iron flake materials are suitable. Typical nickel flakes have lateral dimensions in the range 5-50 microns and a thickness less than 2 microns. Typical iron flakes have lateral dimensions in the range 10-30 microns and a thickness less than 2 microns.

1. A security device comprising:
an array of reflective sampling elements;
a non-dispersive colour-generating relief structure formed in a surface of the reflective sampling elements, the non-dispersive colour-generating relief structure defining an array of image elements across the array of reflective sampling elements;
wherein, the array of image elements defined by the non-dispersive colour-generating relief structure and the array of reflective sampling elements cooperate to exhibit an optically variable effect.

2. The security device according to claim 1, wherein the array of reflective sampling elements comprises an array of convex micromirrors.

3. The security device according to claim 2, wherein the array of reflective sampling elements comprises an array of substantially semi-cylindrical micromirrors or an array of substantially semi-spherical micromirrors.

4. The security device according to claim 1, wherein the array of reflective sampling elements comprises an array of Fresnel micromirrors.

5. The security device according to claim 1, wherein the non-dispersive colour-generating relief structure is modulated across the array of image elements such that the exhibited colour varies across the array of image elements.

6. The security device according to claim 1, wherein the non-dispersive colour-generating relief structure is modulated across at least one image element, such that the or each corresponding image element is a multi-coloured image element.

7. The security device according to claim 1, wherein the non-dispersive colour-generating relief structure comprises an array of plasmonic nanostructures.

8. The security device according to claim 7, wherein the plasmonic nanostructures vary in at least one of their shape, size and spacing across the array of plasmonic nanostructures such that the exhibited colour varies across the array of image elements.

9. The security device according to claim 7, wherein the plasmonic nanostructures vary in at least one of their shape, size and spacing across at least one image element, such that the or each corresponding image element is a multi-coloured image element.

10. (canceled)

11. (canceled)

12. The security device according to claim 1, wherein the non-dispersive colour-generating relief structure comprises a zero order diffractive structure.

13. The security device according to claim 12, wherein the zero order diffractive structure is configured to exhibit rotational colourshift.

14. The security device according to claim 1, wherein the array of image elements comprises a first array of microimages.

15. The security device according to claim 14, wherein the first array of microimages and the array of reflective sampling elements differ in pitch and/or orientation such that they cooperate to exhibit a first optically variable effect owing to the moiré effect.

16. The security device according to claim 14, wherein the non-dispersive colour-generating relief structure defines a second array of microimages, wherein the second array of microimages and the array of reflective sampling elements differ in pitch and/or orientation such that they cooperate to exhibit a second optically variable effect owing to the moiré effect.

17. The security device according to claim 15, wherein the first array of microimages and second array of microimages at least partially overlap one another such that the first and second optically variable effects at least partially overlap, and wherein the first array of microimages and second array of microimages differ in pitch and/or orientation such that the overlapping first and second optically variable effects differ in their perceived depth, perceived movement direction and/or magnification factor.

18. The security device according to claim 16, wherein the non-dispersive colour-generating relief structure is modulated across the array of image elements such that the first array of microimages and the second array of microimages differ in colour.

19. (canceled)

20. The security device according to claim 1, wherein at least one of the image elements has a width of 5 to 50 μm.

21. The security device according to claim 1, wherein the array of reflective sampling elements comprises a two-dimensional array of reflective sampling elements and wherein the array of image elements comprises a two-dimensional array of image elements.

22. (canceled)

23. The security device according to claim 1, wherein the array of reflective sampling elements and the array of image elements defined by the non-dispersive colour-generating relief structure are registered to one another.

24. (canceled)

25. (canceled)

26. A method of manufacturing a security device comprising:
forming an array of reflective sampling elements;
forming a non-dispersive colour-generating relief structure in a surface of the reflective sampling elements, the non-dispersive colour-generating relief structure defining an array of image elements across the array of reflective sampling elements;
such that the array of image elements defined by the non-dispersive colour-generating relief structure and the array of reflective sampling elements cooperate to exhibit an optically variable effect.

27-30. (canceled)
